(19) United States
(12) Patent Application Publication
(10) Pub. No.: US 2025/0207555 A1
(43) Pub. Date: Jun. 26, 2025

(54) Gravitational Energy System

(71) Applicant: Luis Wintergerst Fisch, Guadalajara (MX)

(72) Inventor: Luis Wintergerst Fisch, Guadalajara (MX)

(21) Appl. No.: 18/824,709

(22) Filed: Sep. 4, 2024

Related U.S. Application Data
(60) Provisional application No. 63/580,424, filed on Sep. 4, 2023.

(51) Int. Cl. F03B 17/02

(52) U.S. Cl. CPC F03B 17/02

(57) ABSTRACT

A mechanical, electric and electronic gravitational energy system or generator comprising a vacuum pump, a train drive, a gear system, an alternator, a battery, a speed controller, a flywheel and a servo drive. The system uses the hydrodynamic power of gravity, or buoyant force from the air captured in metallic containers submerged in a water column and suspended by a drive chain to create mechanical torque sufficient to excite the alternator that generates a three-phase alternate current in a single closed, relocatable, intelligent, and compact system to produce clean electrical power and energy. In one embodiment, the generators may be interconnected to the grid or to one or more power distribution substations. Alternative embodiments illustrate methods of installation and of use of the gravitational energy system.

### CROSS-REFERENCES TO RELATED APPLICATIONS

This original non-provisional application claims priority to and the benefit of U.S. provisional application Ser. No. 63/580,424, filed Sep. 4, 2023, entitled “Gravitational Energy System,” which is incorporated by reference herein.

### STATEMENT REGARDING FEDERALLY-SPONSORED RESEARCH OR DEVELOPMENT

Not applicable.

### BACKGROUND OF THE INVENTION

### 1. Field of the Invention

The present invention relates to a clean energy solution generating power by harnessing the gravitational force of the planet. More specifically, the invention is a mechanical, electric and electronic gravitational energy system (GES Technology) and method for generating clean electrical power and energy without being dependent upon fuel, wind, sun or running water, but instead uses air and water as a source of mechanical torque to excite a synchronous alternator that generates a three-phase alternate current in a single closed, relocatable, intelligent, and compact system.

### 2. Description of the Related Art

There exists in the art systems that produce power and energy. However, these existing power and energy producing systems depend on fuel, or alternative renewable energy sources, such as wind, sun or running water, to produce the resulting power and energy.

Accordingly, there is a need for a system capable of generating the necessary power and energy output desired and not be dependent on fuel, or alternative renewable energy sources, to produce the resulting power and energy.

There is a further need for a system that eases the growing demand for clean electrical power required by the industry, agriculture, and global mobility, transportation, data centers, and housing needs of the cities, and generates constant energy and power with a reliable and autonomous system that can interconnect to a microgrid, utility power panels, or the power grid.

The present invention addresses these and other shortcomings of the currently existing power and energy producing systems.

### BRIEF SUMMARY OF THE INVENTION

The physical law of buoyancy states that a body completely or partially submerged in a fluid (gas or liquid) at rest is acted upon by an upward, or buoyant force, the magnitude of which is equal to the weight of the fluid displaced by the body. The weight of the displaced fluid is equivalent to the magnitude of the buoyant force.

For example, a ship that is launched sinks into the ocean until the weight of the water it displaces is just equal to its own weight. As the ship is loaded further, it sinks deeper, displacing more water. The magnitude of the buoyant force matches the weight of the ship and its cargo. Archimedes' formula of buoyancy is given as F=μgV, where:
F=Buoyant force of a given body
ρ=Density of displaced fluid
g=Acceleration due to gravity
V=Volume of the displaced fluid
   Density ρ=ρf−ρb. Here, ρ_{f} is the density of the fluid and ρ_{b} is the density of the body. Hence the formula can also be given as F=(ρᵣ−ρ_{b})gV.

The present invention is a state-of-the-art system exploiting buoyancy principles and featuring modular, relocatable, and expandable technology that produces energy of at least 100 kW per module using Earth's gravitational force without consuming fuel, holding treated water in metallic containers. The present invention produces 100 KW per module and may be installed in different environments, including on interior or exterior environments.

The gravitational energy system of the present invention may be a single unit (a “module”) or include several modules which may be joined together.

The present invention involves two primary systems: a mechanical drive system and an electrical system. The energy or power derived from the mechanical drive system is converted into electrical power to be used (or stored) by a user.

The present invention uses buoyant force from the air in the metallic containers (bodies of air or air buckets or receptacles) submerged in the water column suspended by a drive chain taking advantage of the mechanical force by using a gearbox with a special control servo drive. This increases the revolutions of the system to achieve enough drive speed that excites the central shaft of the synchronous alternator at 900/1800 revolutions per minute (RPM).

The formula from which the rotational torque increase derives is; T=mgr, where T is torque, m is mass, g is gravitational acceleration, and r is the radius of the sprocket. The present invention improves upon prior systems by, inter alia, doubling the torque by increasing the radius of the installed master sprocket by 100%, which also increased the revolutions delivered to the synchronous alternator. The mass multiplied by the gravitational acceleration (9.81 m/s²) is equal to the weight or the upward force of the system.

The present invention further improves upon prior systems by, inter alia, using a speed control encoder that sends a signal to the PLC with the speed index, to track, monitor and control the speed of the system in revolutions per minute using the servo drive. Using this data, the PLC (Programmable Logic Controller) computes the speed adjustment required by the system so that the servo drive on the gearbox makes the corresponding revolution adjustment and delivers the 900 or 1800 RPM required by the alternator.

Such a servo drive will automatically accelerate to deliver the exact speed compensation required by the alternator to comply with the frequency of the grid, electrical panel, or installed equipment as electric load. Normally such frequency is set to 60 Hz in America or 50 Hz in Africa or Europe. The standard deviation accepted in electrical systems is ±5%. The present invention targets a maximum of 2.5% deviation from the target frequency of 60 Hz.

The invention uses a rotary vane vacuum pump with an air filter with a discharge into a pipe that runs the air to the bottom section of the water container. The air outlet has expansion mufflers with a 3-inch pipe with a trident air outlet configuration controlled automatically by the PLC to ensure the proper angle of attack for the bubbles to transfer into the air buckets of the train drive. Such automatic adjustment improves the volume of air inside the buckets to ensure 85% to 90% filling of the air bodies while displacing the water out of the buckets. Once the bubbles reach the inlet holes on each bucket, the air naturally forces the water out.

Once the aquatic train drives carry the upward section buckets with air, the system operates at nominal speed, which is lower than the maximum ascending speed of the air bubble in a column of water. The servo drive system (using the torque from the aquatic train drive), excites the alternator in conjunction with the gearbox to generate 220V or 440V interchangeably and previously set or programmed on the alternator before finishing the installation.

The total instantaneous air volume which is considered as all the air captured in the ascending buckets has an upward force that is converted into rotational speed and torque. Such mechanical speed and torque are then controlled and increased when needed by the servo drive to achieve the revolutions required by the alternator. The alternator produces electrical voltage measured in volts and current measured in amperes, in accordance with the power requirements of an electrical installation receiving the power.

Once the system starts operating, the present invention sustains itself without being connected to an electrical source. This is because the synchronous alternator can continuously charge the batteries and condensers involved, thereby establishing the autonomous constant operating regime (ACOR Mode) generating electric power.

The startup of the system is energized by the two local batteries of 6 KW each to start the vacuum pump. In case of battery depletion, the system will use the existing electrical condensers to start and operate the vacuum pump to fill up the buckets of the ascending train drive side with air, and immediately achieve mechanical movement, speed, and torque to excite the alternator and produce electric power. Once the alternator reaches the targeted 900/1800 RPM, voltage & current settings are achieved. Such a mode will allow the system to recharge the batteries used during the startup. This is akin to the process of how an alternator of an automobile charges the batteries of that same automobile once the automobile (engine) has been started.

A power inverter is used to deliver direct current (DC) to the batteries and capacitors such that there is always enough instantaneous electrical power available to keep the autonomous control system operating in ACOR mode.

The system and method of the present invention (i.e., generating clean power) ensure an instantaneous start even when the optimum water level of the container tank is not full, for best performance. The start of electrical power generation is achieved between 25 and 30 seconds after starting the bucket-filling process with air, and the upward movement of the mechanical drive system is achieved.

The present invention has an energy efficiency of 86% when exciting the synchronous alternator operating at 900 or 1800 RPM. The present invention obtains 78,930 lb.—in or 2,983.5 Kg·f in a hydro-silo or water container with a capacity of 4.8 m or 15.75 feet high of water column. The present invention transmits the available mechanical thrust (buoyancy) power to the upper level of the system, where, through a gear ratio from 1 to 6 (gear shift multiplier to increase 2 times the revolutions achieved by the master sprocket), it is possible to increase the RPM of the underwater drive shafts from 0.85 to 30 RPM required at the input of the gearbox.

The train drive holding the buckets of the downward drive chains gets flooded with water to generate a zero balance of dynamic loads and allows the air trapped in the upward system to generate enough upward vector force to obtain the mechanical torque that will be converted based on mechanical ratio increase to receive 30 RPM and deliver 900/1800 RPM output at the alternator main shaft.

The volume of air present in the buckets—which is equivalent to the volume of water displaced-generates a force equivalent to the volume of water displaced. This displacement of volume of water generates a force equivalent to 1 kg for each liter of water displaced when the density of water is equivalent to 1. The prototype of the present invention has a train drive with 10 ascending air buckets which can handle 351 liters of air. At an 85% filling rate, the present invention yields 298 liters per bucket or 2,983 kg. f on the overall train drive.

The present invention avoids the floating effect of the descending buckets using level sensors that ensure the appropriate amount of water column. The level sensors are controlled by the PLC.

The system of the present invention takes full advantage of the buoyant force of the bubbles or the volume of air suspended (trapped) in the aquatic drive system to generate mechanical torque. The gearbox receives such torque from the aquatic drive and counts with the feedback of the servo drive mounted on the gearbox housing—which is interconnected to the mechanical transmission of the generation system—and provides enough instantaneous supplementary torque to keep the alternator within the nominal speed rate. This capacity is available while feeding the servo drive with an auxiliary feed of direct current (DC) from the batteries and condensers, as needed.

This capacity is available to compensate for the external load generated by the “in-rush motor startups”. The “in-rush” current required by the motors during the first seconds of their startup is the instantaneous high input current drawn by a power supply or electrical equipment at turn-on. It is also known as the “switch-on” surge, or the “input surge” current. Such “in-rush” conditions demand additional power to the alternator during a short period of time. Such power demand creates a speed reduction on the alternator axle which is compensated for by the immediate reaction of the servo gearbox of the system.

The servo gear-specific design for the present invention has the capacity for instantaneous speed ramp-up to compensate for the mechanical tendency of the alternator axle to reduce its nominal speed of 900/1800 RPM. The starting power requirements (in-rush) of the motors on the load side increase between 2 and 3 times the nominal motor current. It is precisely during this period that the gravitational system of the present invention accelerates and balances this peak power demand and its related frequency, measured in Hertz (Hz).

The present invention incorporates a mechanical redundancy incorporating a Flywheel on the axle (shaft) of the alternator to compensate for speed variations during in-rush peak demand events on the rotational speed of the alternator. The flywheel has a heavy wheel attached to the rotating shaft that enables the distribution of a large force evenly across the transmission of the rotational torque of the present invention. The flywheel smooths the speed fluctuations to allow the alternator energy generation flow to be uniform. The flywheel stores energy mechanically as kinetic energy.

The sophisticated speed control system of the present invention is a significant technological advancement. Without the speed control system, all similar systems that use floatation cannot maintain the revolutions per minute when connecting equipment whose startups require additional power. Therefore, the level of instantaneous generated voltage by the generation system would be significantly reduced creating a frequency range mismatch.

The equipment of the present invention uses membranes that allow atmospheric pressure to enter the hydro-silo (water tank) but prevent moisture from escaping from the container (water tank).

In combination with the mechanical system, the present invention uses a sophisticated electronic control that includes a control board, thermo-magnetic switches, a programmable logic controller, and a power module to start the system. The equipment is fully portable. To that end, the present invention includes an automatic water drain that empties the system of water in minutes. The system quickly disconnects clamps from the distribution board to the internal power panels allowing for portability. The system may then be relocated (transferred) in a matter of hours to a remote destination using traditional means for transportation, such as, for example, a platform or lowboy truck or other similar transport vehicle.

The invention developed a platform with hardware and software to control and operate the system remotely using the PLC which can connect to a network using communication ports. It will use a wired ethernet connection or wireless Wi-Fi using the Starlink satellite network. The invention has its user interface or human-machine interface (HMI). The PLC has a Supervisory Control and Data Acquisition (SCADA) software capability to monitor the machine's performance and operation. Data Logging and analysis tools are available to process data, generate reports, and analyze the generation system equipment and systems performance.

This combination of hardware and software allows the user to control and monitor a PLC-based machine remotely, ensuring efficient and secure operations.

The present invention uses a water tank to maintain a body of water with a mechanical structure or frame holding a train drive with chambers or buckets that are filled with air (“air buckets” or “buckets”). Such mechanical drive which contains a great volume of air (10 buckets with 298 liters of air), uses the flotation phenomenon that takes place when placing a body submerged with air in a column of water. This body of air receives a flotation force proportional to the volume of water displaced inside the column of water. When water is used, the fluid density is equivalent to 1 g/cm³=1000 kg/m³. The density (expressed in g/cm³) of the water varies at different temperatures.

The present invention is comprised of a gravitational device having several sub-systems, including, but not limited to, a vacuum pump, a train drive (or bucket power chain or mechanical drive), a gear system, an alternator, a battery, a speed controller and a server.

The vacuum pump generates enough air volume to fill the air tanks of the train drive, or bucket power chain or mechanical drive. This pump works only because enough power is available to power its motor.

The train drive with air buckets are filled with air at the bottom, and then move upwards creating a mechanical force interconnected with a gear subsystem that converts motion into radial torque. The term “train drive” as used herein is synonymous with “bucket power chain” or “mechanical drive.”

The gear system or gear box increases the transmission speed and delivers enough revolutions per minute (RPMs) and torque to the alternator.

The alternator is the fourth sub-system that will utilize the radial speed or RPM to generate alternate power using certified state of the art technology with regulated output voltage and frequency.

The system of the present invention requires an external battery to store electric power that shall be used by the vacuum pump to start the system every time the machine is off.

The system of the present invention includes a speed control such as a programmable logic controller (PLC) using encoders, variable frequency drives (VFDs) and sensors with a pre-programmed sequence used by the system processors.

In an alternative embodiment, the present invention contains several additional other features. For example, the present invention further comprises a communications, computing, diagnostics and security server. The server ensures proper operation, maintenance and problem solving under contingent or exigent circumstances.

In an alternative embodiment, the present invention further comprises a flywheel mechanical rotary assembly. The flywheel mechanical rotary assembly ensures that the system inertial force and speed remain stable while delivering power to an incoming in-rush requirement from the user load.

In an alternative embodiment, the present invention may also include a power converter subsystem which ensures that the frequency, voltage and amperage of the system remain stable during in-rush stages from the user load.

In an alternative embodiment, the present invention may also use satellite communications to conduct autonomous operations. The capacity to conduct autonomous operations ensures operational, diagnostics and corrective maintenance works using a remote server computing platform.

The term “condenser” as used herein is synonymous with “capacitor.”

### BRIEF DESCRIPTION OF THE FIGURES

FIG. 1 is a perspective front view of the gravitational clean electric generator system, including the electrical components thereof, of an embodiment of the present invention.

FIG. 2 is a perspective partial front view of the gravitational clean electric generator system with a portion of the external housing (the front and a side panel) removed to illustrate the internal frame and components of an embodiment of the present invention.

FIG. 3 is a perspective front right view of the gravitational clean electric generator system with the external housing removed to illustrate the internal frame and components of an embodiment of the present invention.

FIG. 4 is a perspective front right view of the gravitational clean electric generator system with the external housing and internal frame removed to illustrate the components of an embodiment of the present invention.

FIG. 5 is a perspective rear view of the gravitational clean electric generator system with housing and internal frame removed to illustrate the components of an embodiment of the present invention.

FIG. 6 is a perspective left front view of the gravitational clean electric generator system illustrating the alternator, flywheel and pulley assemblies of an embodiment of the present invention.

FIG. 7 shows the air vacuum pump, the polyvinyl chloride (PVC) tubing through which air is sent to the bottom of the tank and into the buckets with high efficiency via the PVC three-way splitter (Trident configuration) as an embodiment of the present invention.

FIG. 8 depicts a front view of the electrical components of an embodiment of the present invention, which including batteries, super condensers, power inverter, voltage regulator, electric panel, control panel with user interface, programmable logic controller modules (PLC), external microgrid storage system (100 kW), and energy management system module (EMS).

FIG. 9 depicts a side view of the alternator and shaft extending therefrom with various components connected thereto in an embodiment of the present invention.

FIG. 10 shows a top perspective view of the alternator, vacuum pump and pulley system within an embodiment of the present invention.

FIG. 11 shows a top front perspective of the gravitational energy system of the present invention.

FIG. 12 depicts a diagram illustrating the battery management system incorporating a battery energy storage system (BESS) and showing the interconnection and control elements to fully integrate the charging and power management algorithms required in a power demand project.

### DETAILED DESCRIPTION OF CERTAIN EMBODIMENTS

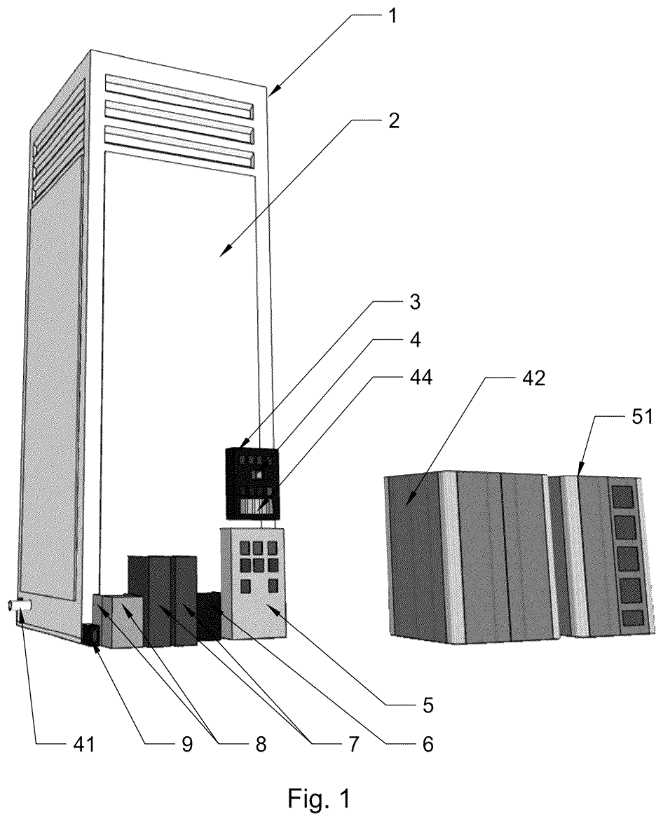

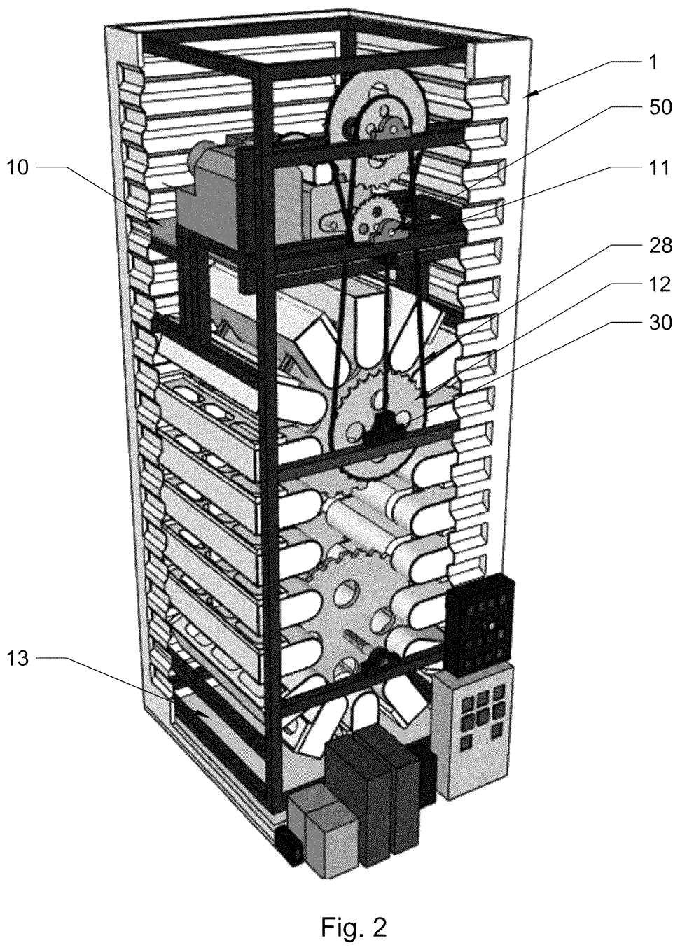

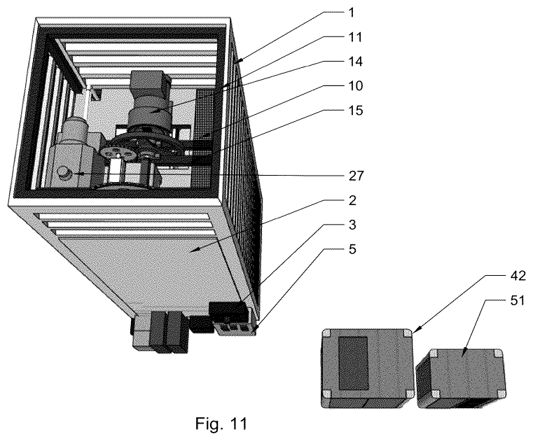

Water Tank. Referring now to FIG. 1 and FIG. 2, water container or tank 1 facilitates the logistics of transporting the gravitational energy system of the present invention overseas. Water tank 1 is a 20-foot standard container. More particularly, the dimensions are 20 ft×8 ft, providing an internal capacity of 1,178 ft³. Water container 1 has two-thirds (⅔) of metallic sheet 2 as steel reinforcement on the external layers of water container 1 starting from the bottom upwards. Drain 41 at the bottom of water container 1 allows for water within water container 1 to be drained out. Steel frame 2 supports the mechanical system on metallic bottom floor 13. Water container 1 contains 5 meters of a water column (not shown) inside. Grated platform or catwalk 10 is located at the upper internal end of water tank 1 around the internal machinery, as shown in FIG. 2. Catwalk 10 is used to gain easy access to the gravitational energy system to maintain and service the mechanical and electrical components thereof. See also, e.g., FIG. 11 (showing catwalk on dry top area of water tank 1). Proper water insulation is performed before inserting and installing train drive module 11 inside.

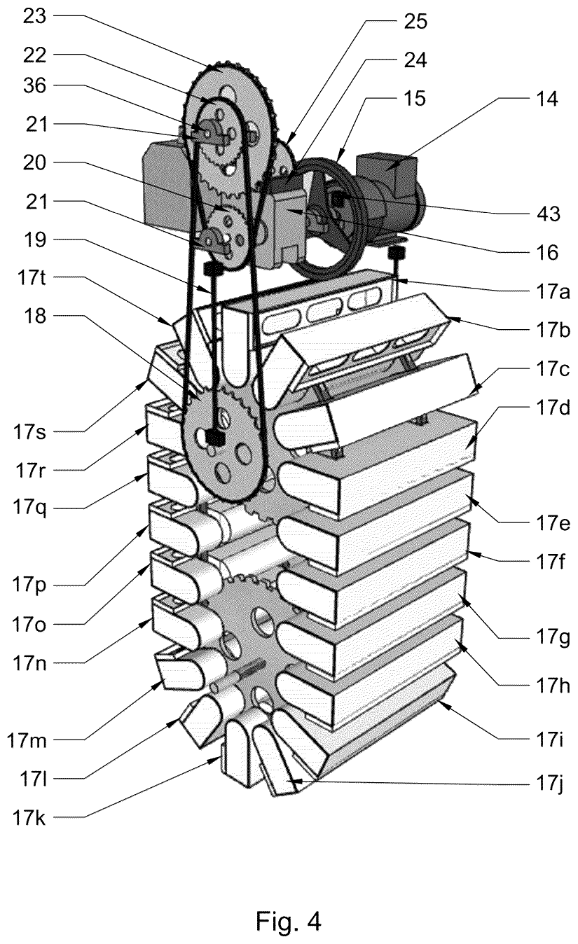

Buoyancy Tanks Suspension System. Referring now to FIGS. 2. 3 and 4, a plurality of buoyance tanks or air buckets 17 are in an evenly spaced array (17a-17t) within water tank 1, as shown in FIG. 4. Buoyance tanks or air buckets 17 are shaped like an inverted wash tub and are suspended on two drive chains 31. Drive chains 31 are suspended over sprocket on shaft 30 with one drive chain at the top of water tank 1 and one drive chain on shaft 34 at the bottom of water tank 1. The test system comprises a total of ten chambers. However, in an alternative embodiment, the present invention may include 22-24 larger buoyance tanks in the production units using a larger water container.

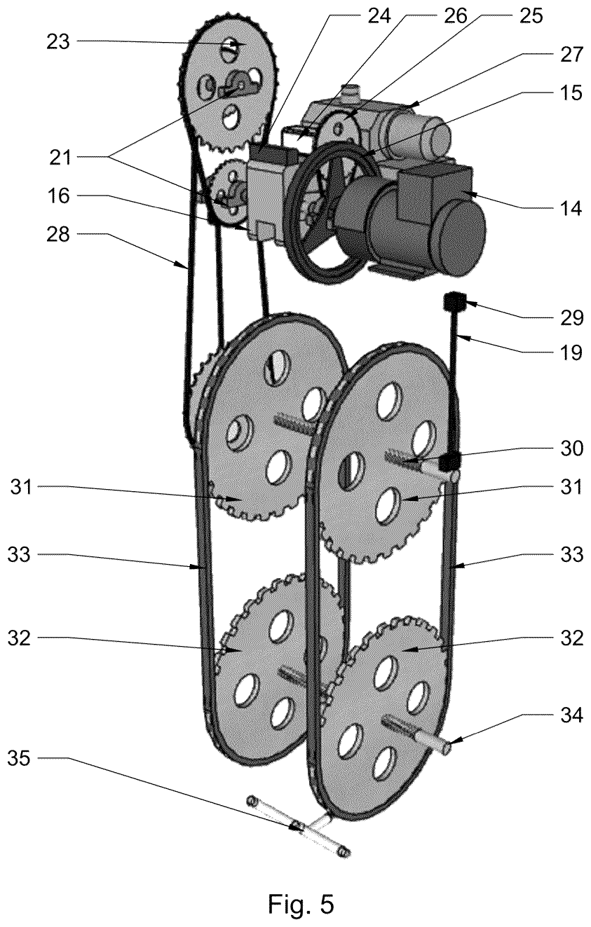

A proprietary technology is used to apply the proper tension on the chain to avoid lagging and/or accelerating and resonance in the suspension system. All the force available on the drive chain is transmitted to the drive and the alternator which is in the upper dry machine compartment. New technology is used in the present invention to apply the proper tension on the chain using automatic tensioning screws 19 (“worm screws”) with automated stepper motor 29, as shown in FIG. 5, to avoid lagging and or accelerating and resonance in the suspension system. All the force available on drive chain 31 is transmitted to gearbox 16 and alternator 14 which is in the upper dry machine compartment using catwalk 10, as shown in FIG. 2. Such a compensation system using step motor 29 is now fully controlled by PLC 44.

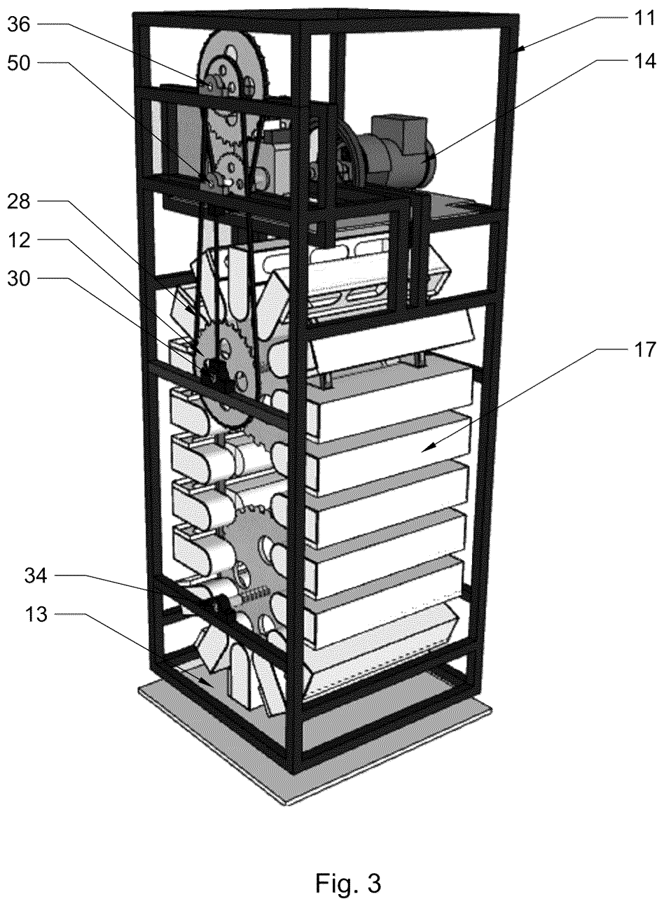

Buoyancy Tanks. Still referring to FIG. 2 and FIG. 3, the design of the air containers or air buckets 17 allows for having two different chambers that balance the dynamic forces involved during the drive train ascension and descension. Air buckets 17a-17j are on the descension side of aquatic drive train 31, 32 (See, e.g., FIG. 5). Air buckets 17k-17t are on the ascension side of the drive train (See, e.g., FIG. 5). Air containers or buckets 17 avoid immersion buoyancy forces, that is, the force needed to submerge air buckets 17a-17j on the downward side. It is critical air buckets 17 always remain immersed. Air buckets 17a-17t do not come out of the fluid at the top or bottom of water tank 1.

It is during the filling of air buckets (17j-17b) when the water is displaced on the ascension drive. Once air buckets 17 complete their ascension, they will release the air, and get flooded with water.

Air Supply. An air volume transfer method fills air buckets 17 in a fleeting period, while the drive train ascends with at least 85% air filling for all air buckets. Air fills air buckets 17 immediately since the ascension of the bubbles of air is faster than the speed of the aquatic train drive.

The system requires more than three hundred liters (300 L) of air per air bucket 17 in the system. The air buckets 17 are filled gradually from the bottom of water tank 1. The gravitational device has integrated a positive displacement blower, and an air distribution system to deliver the massive amount of air required by the buoyancy tanks supported by the power drive chain system.

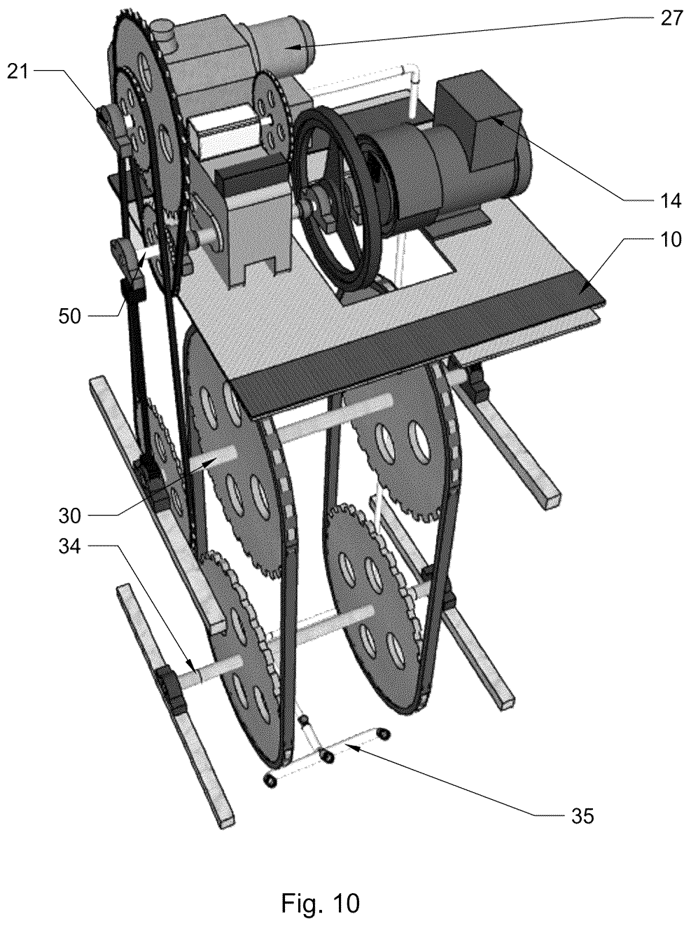

Referring now to FIGS. 5, 7, 8 and 10, the positive displacement blower is trident 35, an intelligent air exhaust mechanism controlled by PLC 44. The gravitational device integrates a positive displacement blower or vacuum pump 27 and an air distribution system to deliver the massive amount of air required by the buoyancy buckets supported by power drive chain system 33 to deliver mechanical power to gearbox 16.

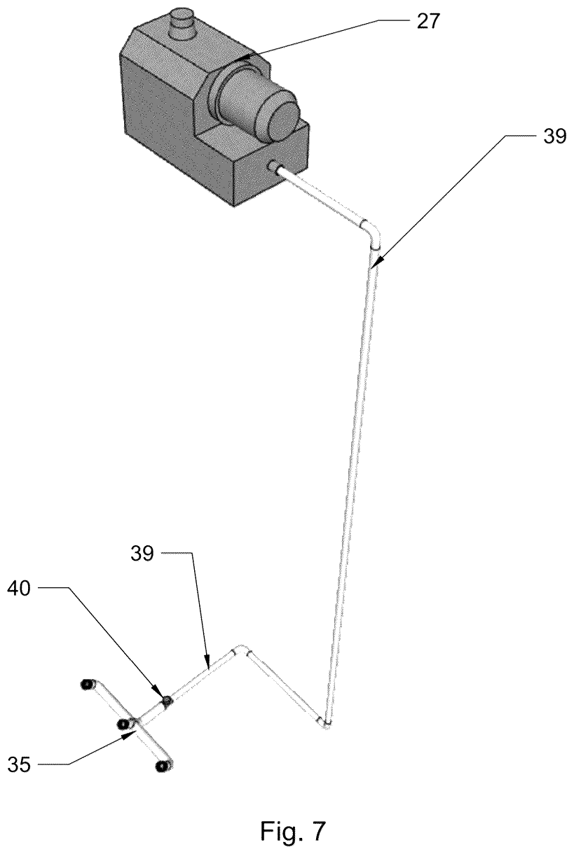

The air distribution system is comprised of vacuum pump 14, master chain aquatic sprocket 28, stepper motor 29, aquatic master shaft 30, upper sprockets 31 of aquatic train drive (air buckets), lower sprockets 32 of aquatic train drive (air buckets), vertical parallel bucket chains 33 of train drive system, lower aquatic shaft 34 of aquatic train drive, air trident assembly 35 (3 outlets for air expansion), shaft 36 (transmission sprockets), gearbox input sprocket 37 (transmission chain), and dented driven gear 38 (connected to gearbox and servo speed control). The air distribution system is further comprised of 2″ PVC air pipe 39 (bottom air trident), check valve 40 (for trident) water drain pipe and valve 41, as shown in FIG. 7 (see also, e.g., FIG. 1). An air pressure of approximately two (2) bars is required for the system to operate continuously. The high volume of air through PVC pipe 39 pressurized at 2 bar is blown to air buckets (17j-17b) at the bottom of water tank 1 with air injection trident 41, which quickly fills air buckets 17 arranged on the upward side of the train drive (17k-17t), as shown in FIG. 4.

Gear Train Drive. The gear train transmits the torque acquired by the aquatic drive train output represented by sprocket 20 and increases the torque up to the operating speed of alternator 14. The required RPM may be up to 2,200 RPM using a custom-made gearbox 16 with an elevation ratio of 1:30. The required RPM may be up to 900 or 1800 RPM depending on the type of synchronous alternator installed.

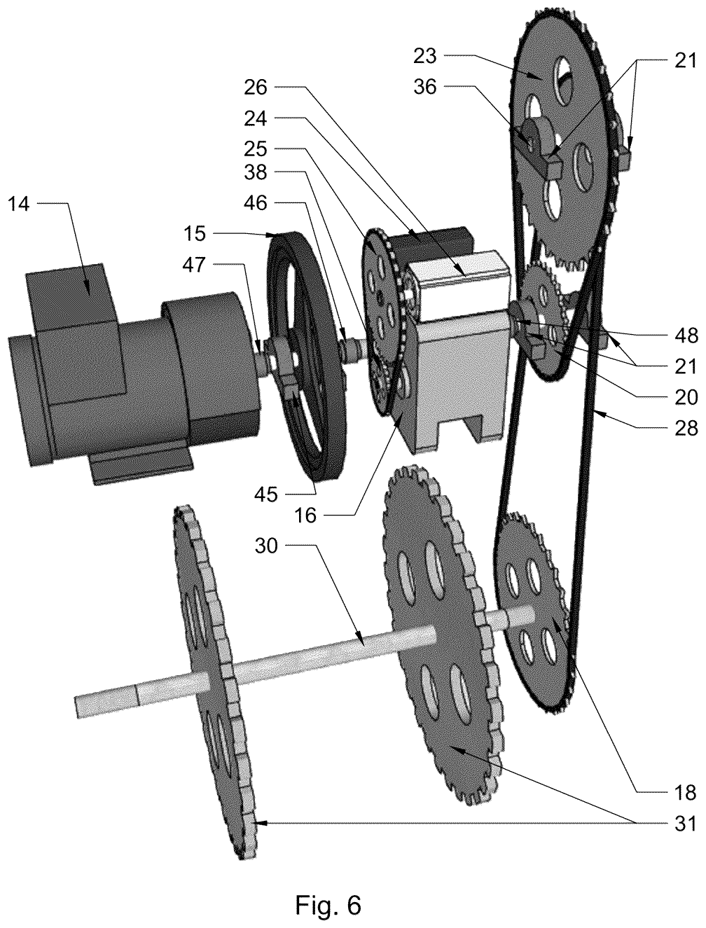

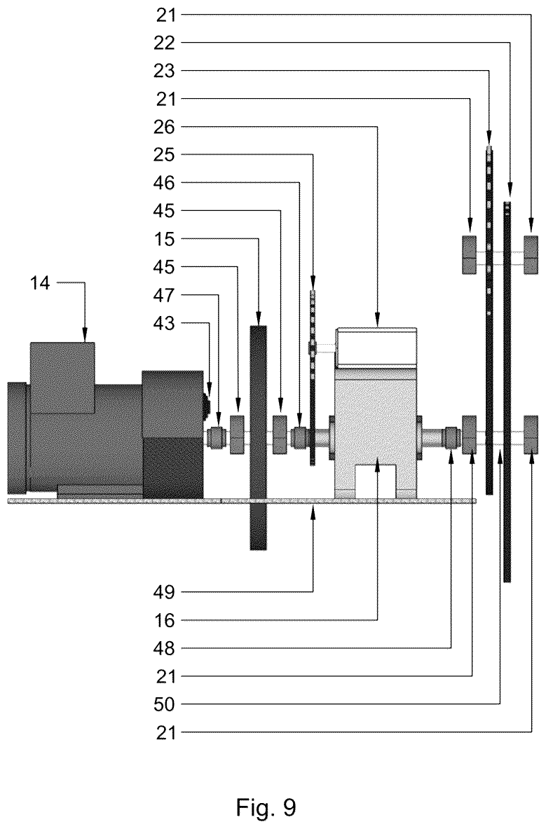

The integration of encoders 43, PLCs 44, servo control 24 (VFDs) and a specialized gear box 16 utilizing servomotor 26 for speed control, represents the most advanced technology available at this moment. Using the power of buoyancy to obtain radial force, torque and movement using peripheral devices to achieve the required transmission speed. Turning now to FIG. 6, the inclusion of flywheel 15 and servo motor 26 integrated to gearbox 16 represents the ultimate technological advancement of the present invention. Flywheel 15 is installed using two bearings. The first bearing or gear box primary output coupling 46 is coupled to the left with the gearbox output. The second bearing or alternator main shaft or axle coupling (47) is coupled with the axle of alternator 14, as shown in FIG. 6 (see also, FIG. 9). The term “shaft” as used herein is synonymous with the term “axle.”

Synchronous Alternator. Referring now to FIGS. 6, 9 and 10, synchronous alternator 14 compensates peak demand and delivers the desired power factor with internal voltage regulators following international standards. The present invention integrates a 136-kW alternator to ensure the delivery of 100 kWh per module, to an electric panel, e.g., a user's electric panel. All the residual energy is used to charge the battery pack, the speed control servo drive, and the vacuum blower, and keep internal electronic equipment energized and operating in a reliable mode.

The output power can be delivered in multiple voltages in either 50 or 60 HZ configurations. The synchronous alternator of the present invention comes with UL, ULc, CE and CSA (Underwriters Laboratories, Underwriters Laboratories-Canada, Conformité Européenne and CSA Group) Certifications, which comply with most international building or safety requirements. Additional requirements are dealt with on a case-by-case basis.

Speed Control PLC. Referring now to FIGS. 1, 5, 6, 8 and 9, the GES technology of the present invention uses PLC 44 controlling a servo drive 24 (with VFDs) to control servo motors 26, and vacuum pump 14, to ensure the transmission sped is within nominal range while generating electric power. Encoder 43 installed on alternator 14 sends the signal to PLC 44 to control and maintain the adequate speed of the mechanical transmission servo drive to ensure peak demand power supply and the proper feedback for the operation.

Servo motors are built to withstand the rigors of continuous operation, resulting in a longer operational lifespan. Their robust construction and efficient design ensure durability and reliability with maximum torque. In the present invention, and referring now to FIG. 6, servo drive 24 has a direct speed regulation capability with high torque using dented gear 25 and a timing belt directly connected to driven gear 38 on gearbox transmission secondary output. Gearbox primary output 46 is coupled to the transmission main shaft of flywheel 15 coupled with the main axle coupling 47 of alternator 14. See also, FIG. 9.

Startup Batteries. The start-up of the system is made using the available charge on two batteries 7 (6 kW each) that ramps up vacuum pump 14 to start-up the overall train drive with ascension movement. The battery is continuously charged once the alternator runs at the nominal speed of 900 RPM.

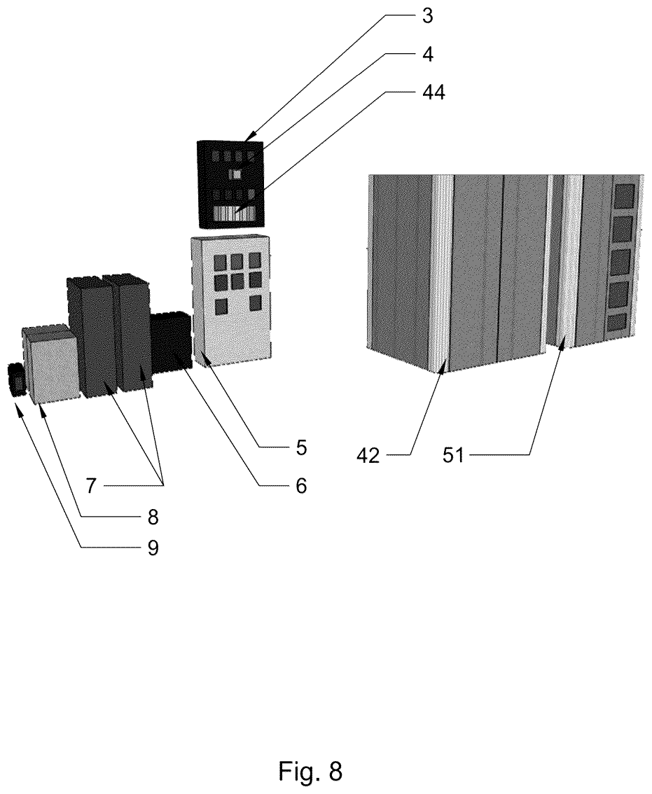

Referring now back to FIG. 1, local batteries 7 are charged using inverter 6 to convert alternating current (AC) to direct current (DC) from the generation circuit of alternator 14. Servo motor 26 also uses DC current from batteries 7. Batteries require direct current (DC) to charge. Therefore, the first step in charging a battery with an AC generator is to convert the AC output to DC. The output of the rectifier/inverter is often still pulsating. To smooth out these pulses, capacitors 8 are used to filter the DC output, providing a more constant voltage to batteries 7. Batteries require a stable and appropriate charging voltage. If the rectified of DC is not at the correct voltage for the battery, voltage regulator 9 is used to ensure that the voltage supplied to battery 7 remains within the safe charging range, as shown in FIGS. 1 and 8.

External Battery or Energy Storage System (BESS). Referring now to FIG. 1 and FIG. 8, battery energy storage system (BESS) 42 enables a power generation system to disconnect, or island, from the main grid and continue to deliver power to critical infrastructure connected thereto. In the present invention, the gravitational system always has a positive power index to perform charging operations during the day, while producing continuous power 24 hours a day.

In the present invention, a 100 kW microgrid is used and operates as a localized energy system with the capacity to generate, store, and distribute power independently or in connection with the main grid.

Components: A typical 100 KW microgrid includes the power generation module, energy storage systems (batteries), and inverters for DC and AC conversion, with power management systems or energy management systems (EMS).

Operation: The gravitational power is either used immediately to supply local loads (homes, businesses, etc.) or stored in external batteries for later use. The system can operate in “island mode” (i.e., disconnected from the main grid) or in “grid-connected mode” where the system interacts with the main utility grid.

### Controlling Power for External Load and Peak Demand:

Load Management: The microgrid uses a smart power management system that monitors real-time power consumption and generation. It prioritizes the distribution of available power to meet the local demand while maintaining system stability.

Peak Shaving: During periods of high demand (peak load), the microgrid can discharge its stored energy to reduce the burden on the main grid or avoid high energy costs, a process known as “peak shaving.”

Demand Response: The microgrid can also participate in demand response programs, where the microgrid adjusts its load or generation based on signals from the utility grid to balance supply and demand.

Referring now to FIG. 11, the inclusion of microgrid 42 brings about substantial cost savings. For example, and not by way of limitation, the 100 KW microgrid 42 of the present invention optimizes energy usage, ensures reliability, and reduces dependency on the main grid, especially during peak demand periods. In another example, microgrid 42 engages in peak shaving (reducing spikes in power usage), load shifting (changing when power is consumed to off-peak times), and participation in ancillary or grid support services by providing power to the grid when requested. All of these functions, along with the capability to maximize renewable energy production, illustrate BESS benefits that can bring about reductions in the electric bill.

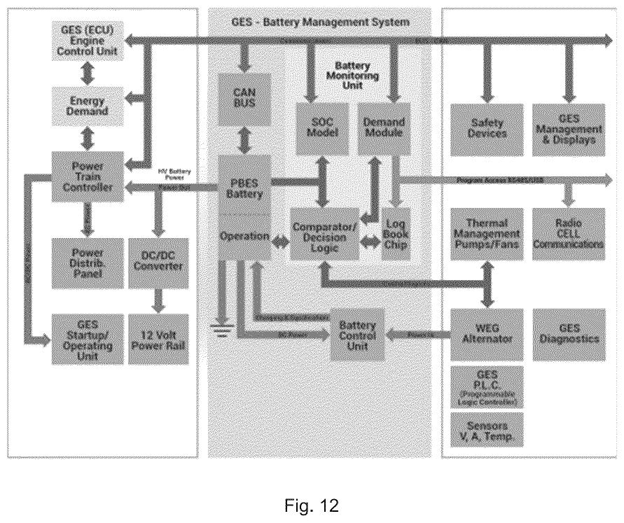

The present invention integrates BESS 42 with a specific design of the interconnection and control elements to fully integrate the charging and power management algorithms required in a power demand project, as illustrated in FIG. 12.

Energy Management System. Connecting microgrid 42 to an electric power system (EPS) requires the microgrid and EPS owners to form a legal contract and a technical design that ensure the safe, reliable, and economic operation of both the microgrid and the EPS (EPS's are also known as macro grids). The point of interconnect (POI) between a microgrid and an EPS commonly requires automatic islanding (separation or decoupling), synchronization (reconnection), and dispatch controls.

The POI relay accomplishes automatic islanding by opening a circuit breaker (or recloser) at the POI. The relay opens the POI when it detects short circuits, open circuits, or backfeed conditions. The relay is configured by skilled engineers to distinguish internal from external system disturbances and to avoid nuisance tripping. Opening the POI provides a crucial indication to the microgrid protection and control systems. The POI opening commonly initiates fast load shedding or distributed energy resource (DER) runback (curtailment) to prevent the microgrid from blacking out. The POI opening indication is also used to change relay protection settings throughout the microgrid to adapt to reduced fault current levels. The POI can also signal DER control systems to change their modes of operation.

Energy management systems (EMSs) (also known as SCADA or distribution management systems [DMSs]) commonly dispatch a POI via a single communications link straight to the POI protective relay. Active and reactive power (or power factor) dispatch is performed by POI relay logic, which simultaneously dispatches multiple DERs. This makes a microgrid with multiple DERs (distributed energy resource) appear to be a single dispatchable generator to a utility. In the present invention, the energy management system depends only upon the gravitational energy system to supply the power needed to sustain the power distribution capabilities based on the electrical engineering performed for every project.

The present invention requires a complex design to provide proper energy management solutions for the system to interconnect local microgrid 42 with the gravitational system generating power for the electrical grid or distribution panels for any type of modern facility.

Tank insulation and reinforcement. Water tank 1 requires heavy metallic exterior reinforcement wall 2 to avoid the expansion of the tank walls due to the hydraulic pressure when filled with 38,000 liters of water. The improvement of the invention includes the design, cutting, and welding of exterior layers of metal sheets for metallic exterior reinforcement wall 2, treated for corrosion, on the exterior walls of water tank 1, minimizing the weight of the steel plate. The system uses treated water which is reusable. The system requires 5% of water makeup to compensate for evaporation every month.

Quality of the Electric Power. The transmission control topology used depends on the required output power and configuration of the system. The invention power control systems are used to control the rotational speed of the transmission system 26 enabling them to operate with optimum speed to extract maximum power from the train drive unit. In summary, the state-of-the-art technology of the present invention is the most important breakthrough of the last 50 years, by creating a double redundancy of the gravitational system and delivering the required frequency in Hertz, the required voltage (V), current (A), and power factor %, required by the local load or grid-specific needs.

Air conditioning and anti-freezing. The present invention integrates air conditioning units for the machine compartment inside water tank 1. Also, an anti-freezing system on the internal base of water tank 1 avoids water freezing using lateral corner bubbling spraying nozzles (not shown) which create sufficient turbulence in the water to prevent ice crystals from forming.

Satellite Communications, auto diagnostics and auto-start. The present invention implements the required instrumentation to use the Starlink Satellite Network to perform the required auto start, autonomous operations, remote diagnostics, and corrective actions from a remotely located distant control room to track, monitor and improve the performance of the gravitational unit while operating in the field.

Robotic surveillance, and Cybersecurity. The current state of affairs on the power generation facilities requires a state-of-the-art design to protect the generation systems from burglary, attacks, explosives, cyber-attacks or other aggressive action. The present invention incorporates the hardware, software and sensors to actively monitor, and react to any threat that may be present at the site of the gravitational system operation.

Predictive Maintenance. A new software platform incorporates state-of-the-art sensors of machines available to feed the predictive maintenance algorithm which gives proper feedback to replace parts, systems, or subsystems before they fail. The medium term between failure (MTBF) information gathered by the gravitational system sensors and data acquisition instruments, determines the proper timing for maintenance activities, parts replacement, or software upgrade. Temperature, vibration, parts wear, and oil analysis are part of the variables into consideration, in addition to the humidity, salinity, or cross-contamination elements in the water tank.

System Summary. The gravitational device of the present invention uses the force of gravity expressed in the Archimedes Formula:

E=ρvg
wherein ρ=density of the liquid, v=volume of air suspended on the water column, and g=gravitational force: 9.81 m/s².

Therefore, buoyancy depends on the density of the fluid, the volume of the body of air inside the column of water, and the existing gravity at that point in space. The buoyancy acts vertically with an upward force vector that is applied to the center of gravity of the body, or Carena Center.

The lifting bodies are filled with air and compressed by the water pressure of the tank. Water is required for a filling and buoyancy-blocking system. Circulating bodies are guided by the aquatic train drive submerged in the water tank. The air bodies are filled with bubbles of air at the bottom of the tank (2 bar of pressure), using the inlet holes, and the liquid exerts pressure on flotation. It is carried at the lower pivot point of a liquid displacement in the rotating and ascending floating bodies of the water outlet openings. The floating bodies will release the air at the top of the train drive while rotating to the descending side, full of water. The terms “lifting bodies,” “air bodies,” “floating bodies,” “bodies,” “metallic containers,” “buoyancy tanks,” and “air buckets” as used herein are intended to be synonymous.

The gravitational device of the present invention requires an external device like the vacuum pump to generate enough volume of air for the train drive to be buoyant and produce mechanical torque on the transmission axle. The air filled on the bodies of the train drive at the bottom of the tank is produced by a vacuum pump which generates a great volume of air bubbles in an amount of 250 m³/hr. with a pressure of 2 bar.

The present invention obtains energy from the mechanical drive rotating with enough torque to elevate the RPM of the system using a gearbox and a servo drive to excite the synchronous alternator generating three-phase electric power at 60 Hz.

The gravitational device of the present invention also requires an external synchronous alternator to generate alternate electric power.

The system of the present invention uses only a fraction of such power to charge the battery. The battery (internal) is used to start up the operation of the pump, and then begin the upward motion of the train drive. However, the system of the present invention cannot start if a battery or power supply are not available to start the pump.

The system cannot generate power if the alternator is not designed to couple and spin with the RPM and torque generated by the transmission system. The gravitational device of the present invention requires a variety of sub-systems. If any of those fails, the system immediately stops functioning.

Mathematics of the system. GES train drive is comprised of twenty (20) air chambers. Ten (10) chambers on the ascension side, with a mechanical design of 351 liters each. Such chambers will fill up to 85% of the available volume, generating 2,983 kg·f (i.e., kg·force of mechanical power).

Such mechanical power equates to 2,983 kg of displaced water with a buoyancy power of 29,240.19 Nm.

The train drive will always run continuously. This is because the vacuum pump generates the required amount of air bubbles or liters per second required (111 liters/s) using a double variable bubble generation system of 470 m³/hr.

The mechanical transmission will elevate the initial 30 rpm to 900 rpm or 1,800 rpm, as required.

The alternator requires 1,450 Nm which are transmitted by the servo drive shaft to the alternator's coupling system to produce 440V with a minimum of 900 rpm. The present invention uses a commercially available custom made alternator by WEG.

The kinetic energy produced instantaneously by the gravitational energy system (GES) of the present invention is 143,279.8 W. Such power is produced by the alternator which, by design, is a 136 kW/hr of nominal power capacity. Such nominal power capacity of the alternator with an efficiency factor of 93% delivers 126 KW/h of consistent electric power.

The vacuum pump producing the buoyant process requires only 8 KW/h. The servo motor requires 10 kW/h and the processor and panel require 5 KW/h for a total of 23 KW/h. The difference between the 126 kW/h nominal power capacity of the alternator and the 23 kW/h total power of the vacuum pump, servo motor, processor and panel (126 kW/h−23 KW/h=100 kW/h) enables the present invention to deliver consistently 100 KW/h directly to a power panel of, for example, the user.

The system has certain losses in the aquatic environment, as well as transmission and water friction, speed regulation, and electrical losses. Such losses would amount to a maximum of 2 kW. The GES of the present invention then uses the remaining 10 kW to charge the battery and energize the electronic panel of the system. The remaining 100 KW are the nominal throughput commercially committed by the system.

The battery has the storage capacity of 12 kW. The alternator will charge the battery in seven (7) minutes, should it be fully depleted. When the GES unit does not have an active battery, the present invention uses the ancillary sub-system of emergency power super capacitors which energize the vacuum pump for 30 seconds to start the system and complete the electrical power feedback loop required to establish nominal operation. Once the electric feedback is established by charging the battery and ensuring the pump runs, the system will keep running continuously.

Perpetual Motion Principle Explanation. Perpetual motion is the action of a device that, once set in motion, would continue in motion forever, with no additional energy required to maintain the motion.

The GES of the present invention is NOT a Perpetual Motion Machine. The gravitational system of the present invention requires external energy to start its operation through the vacuum pump. The gravitational system requires an external storage system (battery) to supply the initial and continued operation of the pump. If the pump motor stops operating, the drive train will keep moving for a few seconds and will then stop. Once the available air is released after the cycle completion there is no buoyant force to keep the train drive moving upwards. The system will simply stop.

Conclusion. The gravitational system of the present invention is not a perpetual motion device. It is a device (machine) that uses the upward motion generated by the suspended volume of air in a column of water (train drive) to produce mechanical torque. Such rotational torque is enough to excite the AC alternator to generate electric power at 220 V-440 V. The alternator keeps the battery charged which energizes the motor of the air vacuum pump. The gravitational system uses only the principles of physics to operate. The system runs cold. The gravitational system of the present invention neither requires nor produces any heat. The water temperature remains stable according to the weather of the environment.

The system requires an external battery and a processor (PLC) to maintain continuous operation. The inventor has a proof-of-concept prototype which has demonstrated the application of the present invention's concept and art.

GES Power converters. Full power converters isolate the generator from the grid and provide the fault ride-through, low voltage ride-through, and dynamic and flexible grid code support including active and reactive power control. The converters set and monitor the generator's torque and speed reference, and guard against sudden jolts caused by grid disturbances that would otherwise add mechanical stress on the drivetrain.

Low voltage full power converters. Direct torque control (DTC) monitors the torque of the generator at 40,000 times per second, enabling the most efficient generator control and providing the foundation for grid code and fault ride-through compliance. Liquid-cooling transfers the heat from the converter to outside the turbine and enables the cabinets to be completely enclosed (with no openings) keeping salty, sandy, and dusty air out. GES Power converters play an important role in helping the system meet these grid code requirements and to obtain the necessary operational certification.

Low voltage ride-through and grid support. A common requirement for all grid codes is a fault ride-through capability where the GES must be capable of operating continuously at reduced voltage and must not trip off-line because of transient voltages. GES farms have to remain connected during voltage dips and to provide active and/or reactive power to the network during the fault. The electrical manufacturing company ABB, formerly Asea Brown Boveri, has designed its GES power converters to provide full reactive current immediately when the grid fault starts.

Coordinated breaker and contactor solutions. Both grid disturbances and normal generation operation result in frequent connection and disconnection of the GES power circuit. To maximize kilowatt-hour production throughout the lifetime of the generator, GES uses a coordinated breaker and contactor solution with breakers for protection and contactors for switching.

Specific surge protective devices (SPD). GES are at risk for lightning strikes. Installing surge protective devices in the electrical drivetrain increases the reliability of the turbine. GES uses specific surge protection solutions to protect all the equipment within the electrical drivetrain, including the generator, converter, contactor and breaker. Grid connection products enable the distribution of the generated power from the alternator to the power plant's collection network. The GES transformer and switchgear are the main components of this system.

Switchgear. The switchgear is a compact switchgear solution for all voltage levels. The switchgear provides switching and protection of GES power plant networks in harsh operating environments. The switchgear has both International Electrotechnical Commission (IEC) and Chinese GB Standard approval, and is the only product approved for the 40.5 kV GB standard. The slim design width of 420 mm for a 36 kV circuit breaker module allows the switchgear to fit through tower doors during installation. Both compact and modular solutions are available in a variety of configurations, and provide for several advantages, including the following:
Solutions available for 12 kV, 24 kV, 36 kV and 40.5 kV
Combination of standardized modules provides full application flexibility
Switch fuse or circuit breaker protection
Advanced solutions for arc protection available
Wide scope of protection and communication solutions

Transformers. Transformers have a compact design that allows the transformer to be installed easily. They are engineered to reduce losses and operate in environments with high vibrations as well as harsh ambient conditions where salt, sand, dust, and relative humidity of 100% are common. The transformers are available in a variety of configurations, and provide for several advantages, including the following:
Dry transformers up to 72.5 kV and 40 MVA
Liquid filled transformers up to 72.5 kV and 40 MVA.
Classes E2, C2, F1.
Multiple forced cooling system solutions
Insulation system temperature up to 180° C. for dry transformers
Organic liquid cooling options

The present invention has several additional features, such as tank insulation, a steel frame, electrical protections, security, PLC control, power converter, energy storage and EMS. The water tank includes an interior insulation to avoid water leaks and also includes exterior reinforcement for mechanical expansion. The steel frame is designed for robotic boring and facilitates increased train drive installation. Heavy duty, corrosion free steel makes up the frame, gears and chains.

For electrical protection, the present invention includes panels, switches and sensors which are insulated and heavy duty with quick disconnects and short circuit protection. The present invention further includes security features on the instrumentation to avoid burglary and theft, incorporates GPS, anti-approaching gas, sound and user detection devices, as well as password protection and network integration capabilities with satellite internet constellations, such as Starlink.

The PLC control of the present invention has temperature, electrical variables, speed control, power delivery, servo drive master control using a commercially available user interface platform, such as Siemens User Interface Platform. The power electrical converter panel ensures frequency, amperage and voltage stability. The present invention further includes a 10% storage assurance and micro grid capacity for peak demand and startup operations. The EMS includes power delivery control management to ensure sourcing to client CCM with intelligent, adaptable and powerful interconnection capabilities.

The various embodiments described herein may be used singularly or in conjunction with other similar devices. The present disclosure includes preferred or illustrative embodiments of specifically described apparatuses, assemblies, and systems. Alternative embodiments of such apparatuses, assemblies, and systems can be used in carrying out the invention as described herein. Other aspects and advantages of the present invention may be obtained from a study of this disclosure and the drawings.

I claim:

1. A gravitational energy system comprising:
a housing;
a frame within said housing;
a vacuum pump within said housing;
an alternator within said housing and electrically connected to said vacuum pump;
a gear box connected to said alternator;
a train drive connected to said gear box;
a plurality of receptacles movably attached to said train drive;
a gear system attached to said plurality of receptacles,
at least one battery electrically connected to said alternator;
at least one capacitor electrically connected to said at least one battery;
a volt regulator electrically connected to said at least one battery;
a speed controller electronically connected to said alternator;
a flywheel connected to said alternator and to said gear box; and
a servo drive connected to said flywheel, wherein water comprises at least two thirds of the volume of said housing, said water completely submerging said train drive and said plurality of receptacles.

2. The gravitational energy system, as recited in claim 1, further comprising a microgrid storage system external to said housing.

3. The gravitational energy system, as recited in claim 1, further comprising an energy management system external to said housing, said energy management system electrically connected to said microgrid storage system.

4. The gravitational energy system, as recited in claim 1, further comprising an encoder electrically connected to said alternator.
